(19) United States
(12) Patent Application Publication
(10) Pub. No.: US 2024/0116298 A1
(43) Pub. Date: Apr. 11, 2024

(54) PRINTED IMAGE DATA GENERATION METHOD, PRINTING METHOD, AND PRINTED IMAGE DATA GENERATION APPARATUS

(71) Applicant: Panasonic Intellectual Property Management Co., Ltd., Osaka (JP)

(72) Inventors: KEIJIRO MASUNAGA, Osaka (JP); RYOJI HYUGA, Osaka (JP)

(21) Appl. No.: 18/475,293

(22) Filed: Sep. 27, 2023

(30) Foreign Application Priority Data
Oct. 7, 2022 (JP) 2022-162393
Sep. 7, 2023 (JP) 2023-145201

(51) Int. Cl. B41J 3/407; B41J 2/045; B41J 11/00; B41J 25/20; G06T 1/20

(52) U.S. Cl. CPC B41J 3/4073; B41J 2/0451; B41J 2/04558; B41J 11/008; B41J 25/20; G06T 1/20; G06T 2200/04

(57) ABSTRACT

A printed image data generation method includes: a data acquisition step of acquiring data indicating a three-dimensional shape model imitating a printing target object and data indicating a two-dimensional image for decorating a surface of the printing target object; and a printed image data generation step of calculating a position of a surface of the three-dimensional shape model on which ink ejected from a nozzle is to land, determining a pixel of the two-dimensional image corresponding to the position of the surface, and generating data of a printed image to be printed on the printing target object based on information of the pixel.

### BACKGROUND

### 1. Technical Field

The present disclosure relates to a printed image data generation method, a printing method, and a printed image data generation apparatus.

### 2. Description of the Related Art

In recent years, there has been an increasing demand for printing two-dimensional images on a three-dimensional medium. In order to meet such a demand, a three-dimensional inkjet printer as described in PTL 1 has been proposed.

The three-dimensional inkjet printer generates two-dimensional pseudo three-dimensional image data having coordinate information of a three-dimensional image by associating three-dimensional image data of a medium having a shape of a sphere, a column, or a truncated cone with two-dimensional coordinates by performing coordinate conversion using a mathematical expression corresponding to each shape.

Then, the three-dimensional inkjet printer performs halftone processing on the pseudo three-dimensional image data, and generates two-dimensional halftone image data indicating gradation corresponding to CMYK, which is colors of ink.

Thereafter, the three-dimensional inkjet printer performs a process of three-dimensionalizing the two-dimensional halftoned image data to generate three-dimensional halftoned image data corresponding to the shape of the three-dimensional medium, and prints an image on the medium based on the three-dimensional halftoned image data.

### CITATION LIST

### Patent Literature

PTL 1: Japanese Patent No. 5699367

### SUMMARY

A printed image data generation method according to one aspect of the present disclosure includes: a data acquisition step of acquiring data indicating a three-dimensional shape model imitating a printing target object and data indicating a two-dimensional image for decorating a surface of the printing target object; and a printed image data generation step of calculating a position of a surface of the three-dimensional shape model on which ink ejected from a nozzle is to land, determining a pixel of the two-dimensional image corresponding to the position of the surface, and generating data of a printed image to be printed on the printing target object based on information of the pixel.

A method for printing a two-dimensional image on a three-dimensional object by an inkjet head according to an aspect of the present disclosure includes: preparing three-dimensional model data indicating a three-dimensional model generated from the three-dimensional object; preparing binarized image data indicative of a binarized image generated from the two-dimensional image, the binarized image including a plurality of binarized image pixels, each of the plurality of binarized image pixels having a pixel value indicative of presence or absence of a color; preparing nozzle trajectory data indicating a plurality of trajectories in which a plurality of nozzles included in the inkjet head move; generating printed image data based on the binarized image data and the nozzle trajectory data, the printed image data including a plurality of printed image pixels corresponding one-to-one to the plurality of binarized image pixels, each of the plurality of printed image pixels having a pixel value indicative of a nozzle assignment. Here, generation of the printed image data includes: determining that a first nozzle of the plurality of nozzles passes over a first binarized image pixel having a pixel value indicative of the presence of a color among the plurality of binarized image pixels; assigning the first nozzle to a first printed image pixel corresponding to the first binarized image pixel among the plurality of printed image pixels; determining that a second nozzle different from the first nozzle among the plurality of nozzles passes over the first binarized image pixel; determining a second binarized image pixel having a pixel value indicating that the binarized image pixel has a color located within a predetermined distance from the first binarized image pixel; and assigning the second nozzle in addition to the first nozzle to the first printed image pixel in response to determining the second binarized image pixel.

A printed image data generation apparatus according to one aspect of the present disclosure includes: a data acquisition unit that acquires data indicating a three-dimensional shape model imitating a printing target object and data indicating a two-dimensional image for decorating a surface of the printing target object; and a printed image data generator that calculates a position of a surface of the three-dimensional shape model on which ink ejected from a nozzle is to land, determines a pixel of the two-dimensional image corresponding to the position of the surface, and generates data of a printed image to be printed on the printing target object based on information of the pixel.

### BRIEF DESCRIPTION OF THE DRAWINGS

FIG. 1A is a view showing a printing target object whose surface is a planar surface;

FIG. 1B is a view showing a printing target object whose surface is curved in one direction;

FIG. 1C is a view showing a printing target object whose surface is a free curved surface;

FIG. 2 is a view for describing an influence of movement along a curve of an inkjet head having a plurality of nozzle rows on printing;

FIG. 3 is a view showing an example of a printing apparatus according to a first exemplary embodiment;

FIG. 4 is a view showing an example of trajectory data according to the first exemplary embodiment;

FIG. 5 is a view showing an example of conversion processing into a raster image;

FIG. 6 is a view showing an example of a coordinate system for defining a nozzle position;

FIG. 7 is a view showing an example of nozzle position data;

FIG. 8 is a view showing an example of the coordinate system for defining the nozzle position in a case where there is a plurality of nozzle rows;

FIG. 9 is a view showing an example of nozzle position data in a case where there is a plurality of nozzle rows;

FIG. 10 is a view exemplifying a part of a surface decoration shape model;

FIG. 11 is a view exemplifying a part of a surface decoration image;

FIG. 12 is a view showing a description example of a UV map according to a WaveFrontObj file format;

FIG. 13 is a view showing an example of first-stage print control processing;

FIG. 14 is a view showing an example of second and subsequent stages of print control processing;

FIG. 15 is a view for describing a deviation of a landing position of ink ejected from an inkjet head;

FIG. 16 is a view showing an example of a printing apparatus according to a second exemplary embodiment;

FIG. 17 is a view for describing landing deviation data;

FIG. 18 is a view for describing general deviation correction;

FIG. 19 is a view for describing the deviation correction according to the second exemplary embodiment;

FIG. 20 is a view for describing the deviation of the landing position caused by a difference in ejection angle for each nozzle;

FIG. 21 is a view for describing the deviation of the landing position caused by a difference in ejection speed for each nozzle;

FIG. 22 is a view for describing an algorithm for generating printed image data; and

FIG. 23 is a view for describing an algorithm for generating printed image data.

### DETAILED DESCRIPTIONS

The technique disclosed in PTL 1 uses mathematical expressions derived from the shape of a sphere, a column, or a truncated cone to perform association with the two-dimensional coordinates, and thus is applicable to printing on a medium having a simple shape from which such mathematical expressions are derived. However, it is difficult to apply the technique disclosed in PTL 1 to printing on a medium having the free curved surface, such as a sporting good having the free curved surface like a helmet of a road bike or a racket of tennis, a wearable terminal having a housing formed to match a curved surface of a human body, or a digital signage including a plurality of curved surfaces.

An object of the present disclosure is to provide a printed image data generation method, a printing method, and a printed image data generation apparatus capable of easily printing an image even when a surface of a printing target object is the free curved surface.

Hereinafter, the exemplary embodiments of the printed image data generation method, the printing method, and the printed image data generation apparatus will be described with reference to the drawings. Note that, the following disclosure is merely an example and does not limit the scope of the claims. The technique described in the claims includes various variations and changes of the specific examples exemplified below.

### First Exemplary Embodiment

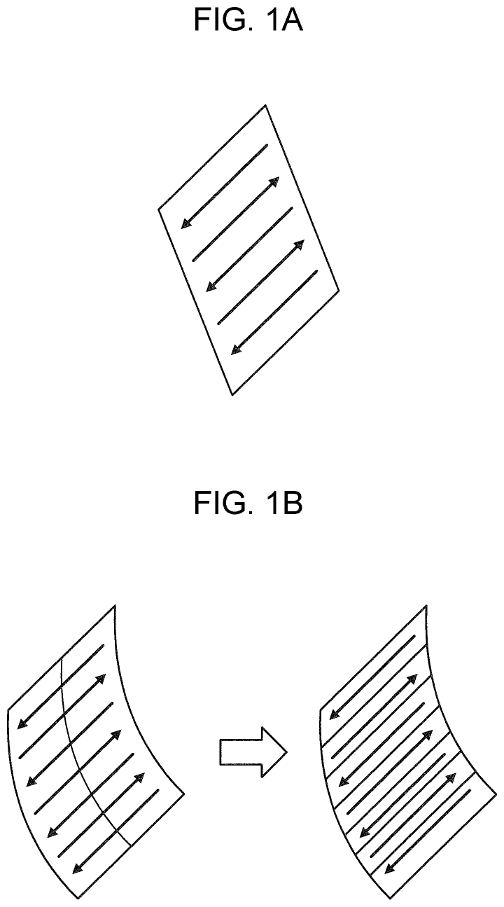

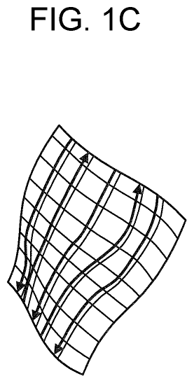

FIG. 1A is a view showing a printing target object whose surface is a planar surface. FIG. 1B is a view showing a printing target object whose surface is curved in one direction. FIG. 1C is a view showing a printing target object whose surface is a free curved surface. Note that, arrows in FIG. 1A to FIG. 1C indicate directions in which the inkjet head scans the surface of the printing target object during printing.

As shown in FIG. 1A, in a case where the surface is a planar surface, printing can be easily performed without performing special processing on the printed image data. Furthermore, as shown in FIG. 1B, even when the surface of the printing target object is curved in one direction, if the surface is divided into a plurality of planes, printing can be performed similarly to the case of FIG. 1A.

On the other hand, in a case of the printing target object in which the surface is the free curved surface as in FIG. 1C, conventionally, a designer manually expands and contracts the printed image to fit a surface shape of the printing target object, so that the printed image can be printed on the printing target object.

However, it is difficult to appropriately perform such processing on the printing target object having a complicated surface shape. Furthermore, as described above, it is also difficult to apply the technique of PTL 1 to such a printing target object whose surface is the free curved surface.

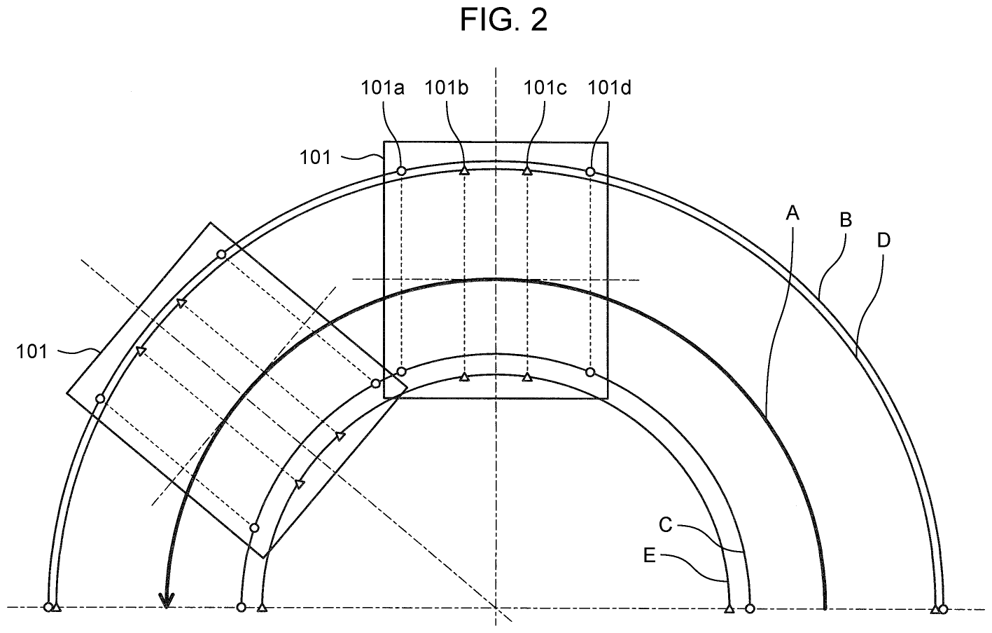

FIG. 2 is a view for describing an influence of movement along a curve of inkjet head 101 including a plurality of nozzle rows on the printing. In a case where the surface of the printing target object is the free curved surface, a situation in which inkjet head 101 moves along the curve during printing may occur.

In the example of FIG. 2, inkjet head 101 includes first nozzle row 101a, second nozzle row 101b, third nozzle row 101c, and fourth nozzle row 101d. First nozzle row 101a and fourth nozzle row 101d are arranged so as to sandwich second nozzle row 101b and third nozzle row 101c.

Furthermore, FIG. 2 shows a trajectory A drawn by a center of inkjet head 101 moving along an arc, a trajectory B and a trajectory C drawn by the nozzles at both ends of first nozzle row 101a and fourth nozzle row 101d, and a trajectory D and a trajectory E drawn by the nozzles at both ends of second nozzle row 101b and third nozzle row 101c.

In a case of performing printing by moving such inkjet head 101 along the arc, since there are nozzles having different rotation radii as in the trajectories B to E, for example, in order to land the ink ejected from the nozzles belonging to second nozzle row 101b on the same region as the ink ejected from the nozzles belonging to first nozzle row 101a, complicated correction according to a difference in rotation radius needs to be performed on the pixels of the printed image.

Note that, in FIG. 2, a case where the rotation radius and a rotation center of each of the trajectories A to E are constant is shown, but in a case where printing is performed on an actual printing target object whose surface is the free curved surface, the rotation radius and the rotation center continuously change, and thus more complicated correction is required.

In view of the circumstances above, the first exemplary embodiment discloses a printed image data generation method, a printing method, and a printed image data generation apparatus that enable easy printing of an image even when the surface of the printing target object is the free curved surface.

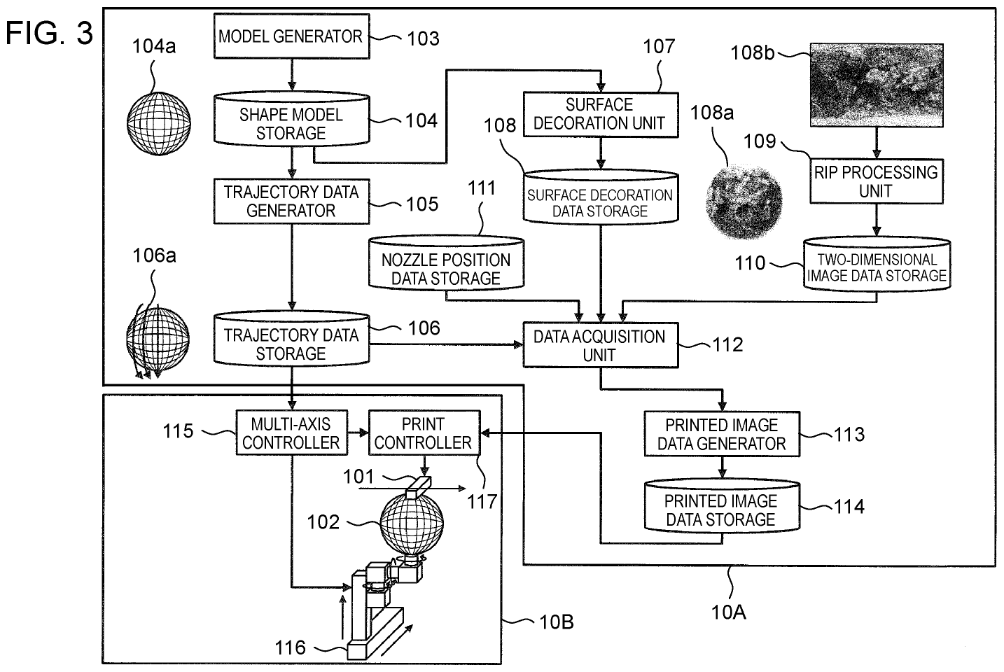

Next, an example of the printing apparatus according to the first exemplary embodiment will be described. FIG. 3 is a view showing an example of a printing apparatus according to the first exemplary embodiment. The printing apparatus ejects ink from a nozzle provided in inkjet head 101 to decorate the surface of workpiece 102 having a three-dimensional shape.

The printing apparatus includes printed image data generation apparatus 10A and print processing apparatus 10B. Printed image data generation apparatus 10A generates printed image data to be printed on workpiece 102 that is the printing target object. Print processing apparatus 10B performs printing on workpiece 102 using the printed image data generated by printed image data generation apparatus 10A.

Hereinafter, a printing apparatus in which printed image data generation apparatus 10A and print processing apparatus 10B are integrated will be described, but printed image data generation apparatus 10A and print processing apparatus 10B may be separate apparatuses.

In this case, a transfer of the printed image data from printed image data generation apparatus 10A to print processing apparatus 10B may be performed by communication processing via a network, or may be performed by storing the printed image data generated by printed image data generation apparatus 10A in a storage medium such as a universal serial bus (USB) flash memory and causing print processing apparatus 10B to read the printed image data.

Printed image data generation apparatus 10A includes model generator 103, shape model storage 104, trajectory data generator 105, trajectory data storage 106, surface decoration unit 107, surface decoration data storage 108, RIP processing unit 109, two-dimensional image data storage 110, nozzle position data storage 111, data acquisition unit 112, printed image data generator 113, and printed image data storage 114.

Model generator 103 is a processing unit that generates three-dimensional shape model 104a imitating workpiece 102, and is realized by three-dimensional computer aided design (CAD) software or the like. Shape model storage 104 stores three-dimensional shape model 104a generated by model generator 103.

Trajectory data generator 105 is a processing unit that generates trajectory data 106a including information on the trajectory of inkjet head 101 in a case where inkjet head 101 scans the surface of workpiece 102, and is realized by computer aided manufacturing (CAM) software or the like. Trajectory data storage 106 stores trajectory data 106a generated by trajectory data generator 105.

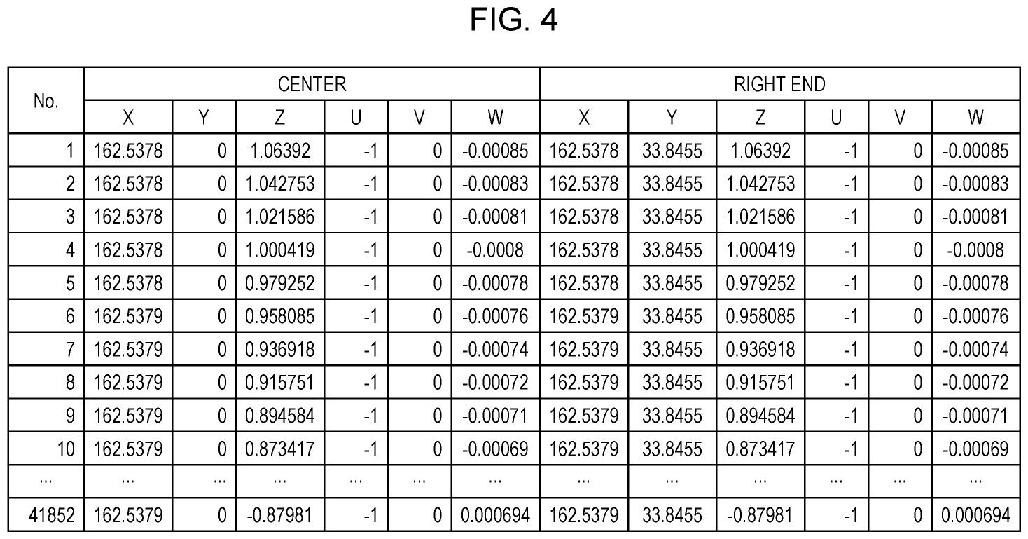

FIG. 4 is a view showing an example of trajectory data 106a according to the first exemplary embodiment. As shown in FIG. 4, trajectory data 106a includes information of a change in each of three-dimensional coordinates (X, Y, Z) of a center of inkjet head 101 that scans the curved surface of workpiece 102, a three-dimensional vector (U, V, W) indicating a vertical direction of a nozzle surface at the center of inkjet head 101, three-dimensional coordinates (X, Y, Z) of a right end of inkjet head 101, and the three-dimensional vector (U, V, W) indicating the vertical direction of the nozzle surface at the right end of inkjet head 101.

Note that, a format of trajectory data 106a varies depending on the CAM software to be used, but may be any format as long as it includes information corresponding to the position and attitude angle (roll, pitch, yow) of inkjet head 101 that change from moment to moment.

Surface decoration unit 107 performs surface decoration on three-dimensional shape model 104a of workpiece 102 generated by model generator 103 to generate surface decoration shape model 108a. Surface decoration shape model 108a is, for example, a three-dimensional shape model in which the surface decoration is performed using a general texture mapping method in a field of computer graphics.

Surface decoration unit 107 attaches surface decoration image 108b corresponding to a texture image in the texture mapping to three-dimensional shape model 104a to generate surface decoration shape model 108a.

Furthermore, when generating surface decoration shape model 108a, surface decoration unit 107 also generates data indicating a correspondence relationship between the position of a point in three-dimensional shape model 104a and the position of a point in surface decoration image 108b. The UV map used in the texture mapping is an example of data indicating such a correspondence relationship.

Surface decoration data storage 108 stores surface decoration shape model 108a generated by surface decoration unit 107. Surface decoration shape model 108a also includes data indicating the correspondence relationship between the positions of points in three-dimensional shape model 104a and the positions of points in surface decoration image 108b.

RIP processing unit 109 is a processing unit that converts surface decoration image 108b into a raster image necessary for actual printing, and is realized by raster image processing unit (RIP) software or the like.

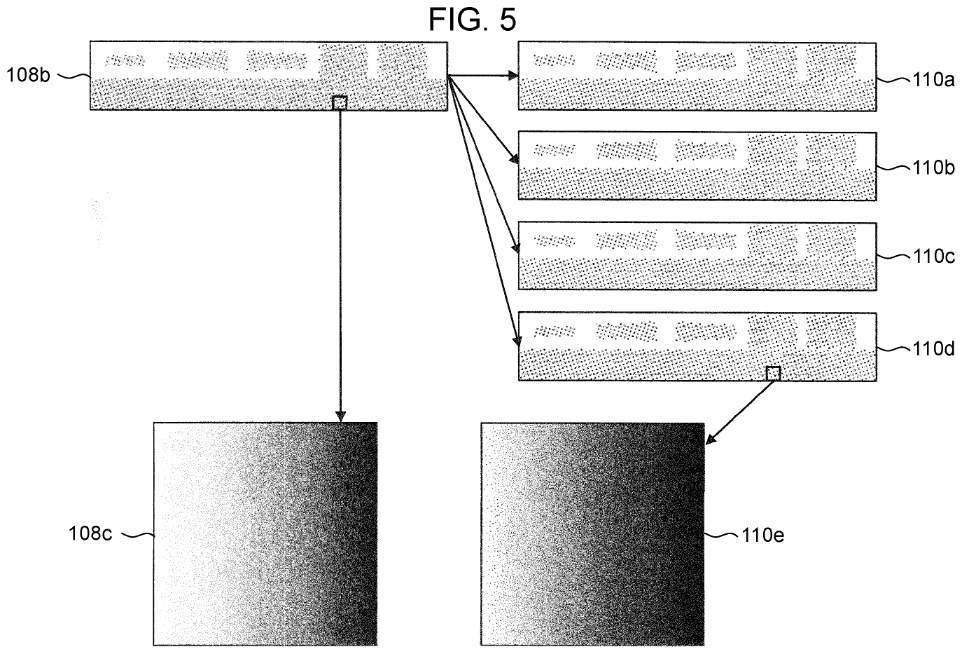

FIG. 5 is a view showing an example of conversion processing into a raster image. For example, RIP processing unit 109 converts surface decoration image 108b expressed by three primary colors of RGB into four binary images 110a to 110d expressed by four colors of CMYK, respectively.

As shown in enlarged view 108c, surface decoration image 108b can express gradation in a stepless manner, whereas the number of gradations is limited in the binary images as shown in enlarged view 110e. RIP processing unit 109 generates binary images 110a to 110d so as to have the number of gradations that can be printed by the printing apparatus.

Here, in binary images 110a to 110d, color information is expressed by binary values of 0 and 1, where 0 corresponds to not ejecting ink, and 1 corresponds to ejecting ink. Note that, depending on the color to be expressed, the color may be further separated into several colors in addition to each color of CMYK.

Two-dimensional image data storage 110 stores the data of the four binary images 110a to 110d obtained as a result of the conversion processing by RIP processing unit 109 as raster image data which is data of a two-dimensional image.

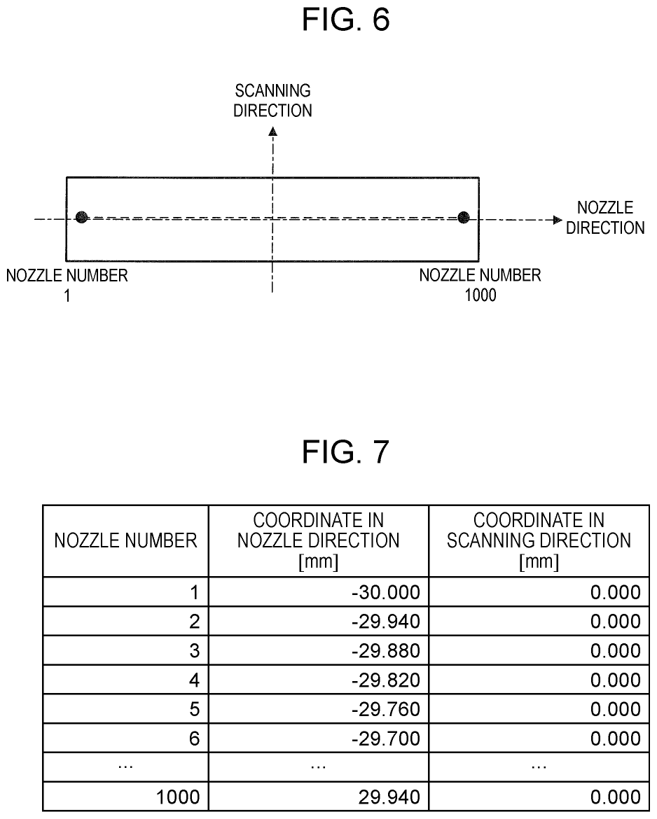

Nozzle position data storage 111 stores nozzle position data indicating the nozzle position of the inkjet head used for actual printing. FIG. 6 is a view showing an example of a coordinate system for defining a nozzle position. FIG. 7 is a view showing an example of nozzle position data.

As shown in FIG. 6, in this example, a direction in which inkjet head 101 scans workpiece 102 is a scanning direction, and a direction orthogonal to the scanning direction and in which nozzles with nozzle numbers 1 to 1000 are arranged is a nozzle direction.

FIG. 7 shows the example of nozzle position data in which the coordinates in the nozzle direction increase by 0.06 mm every time the nozzle number increases by 1 and the coordinates in the scanning direction all become 0.

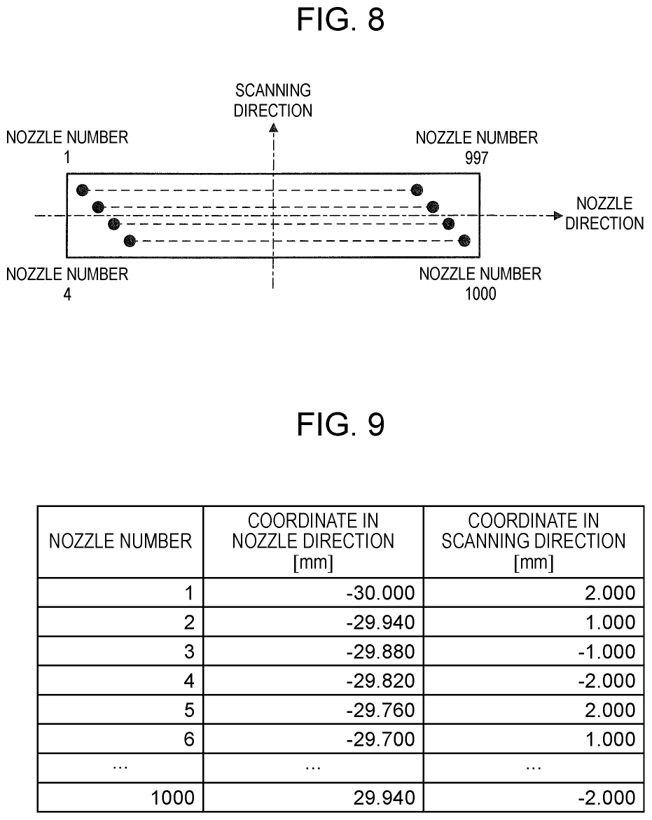

Next, a case where inkjet head 101 has the plurality of nozzle rows will be described. FIG. 8 is a view showing an example of the coordinate system for defining the nozzle position in a case where there is a plurality of nozzle rows. FIG. 9 is a view showing an example of nozzle position data in the case where there is a plurality of nozzle rows.

As shown in FIG. 8, in this example, four nozzle rows are arranged at equal intervals in the scanning direction. Furthermore, as shown in FIG. 9, the coordinate in the nozzle direction increases by 0.06 mm every time the nozzle number increases by 1. Furthermore, the coordinates of nozzle numbers 4n-3, 4n-2, 4n-1, and 4n (n is an integer of 1 or more and 250 or less) in the scanning direction are 2.000 mm, 1.000 mm, −1.000 mm, and −2.000 mm, respectively.

As shown in FIG. 8, in a case where inkjet head 101 has the plurality of nozzle rows, as described in FIG. 2, there arises a problem that complicated correction due to the difference in the rotation radius of the nozzles is required.

Note that, the direction in which the nozzles are arranged in inkjet head 101 may be inclined in a range of greater than 0 degrees and smaller than 90 degrees with respect to the scanning direction of inkjet head 101. As a result, this enables high-resolution printing.

Data acquisition unit 112 acquires trajectory data 106a stored in trajectory data storage 106, the data of surface decoration shape model 108a stored in surface decoration data storage 108, the data of binary images 110a to 110d stored in two-dimensional image data storage 110, the data of the nozzle position stored in nozzle position data storage 111, and the like, and outputs the data to printed image data generator 113.

Printed image data generator 113 calculates the position of the surface of three-dimensional shape model 104a on which the ink ejected from the nozzle lands, determines the pixels of binary images 110a to 110d, which are two-dimensional images corresponding to the position of the surface, and generates the data of the printed image to be printed on the printing target object based on the information of the pixels.

For example, printed image data generator 113 calculates the attitude angle and the nozzle position of inkjet head 101 according to the printing resolution based on trajectory data 106a, in a case of causing inkjet head 101 having a nozzle arrangement shown in the nozzle position data to scan the surface of surface decoration shape model 108a.

Subsequently, for each combination of the attitude angle and the nozzle position of inkjet head 101, printed image data generator 113 determines whether or not a vertical line perpendicular to the nozzle surface of inkjet head 101 provided with a plurality of nozzle holes intersects the surface of surface decoration shape model 108a.

Then, in a case where the vertical line intersects with the surface of surface decoration shape model 108a, printed image data generator 113 reads the data of the pixels of binary images 110a to 110d of CMYK corresponding to an intersection portion from the raster image data, thereby generating data indicating whether or not to eject each ink of CMYK for each pixel as the printed image data.

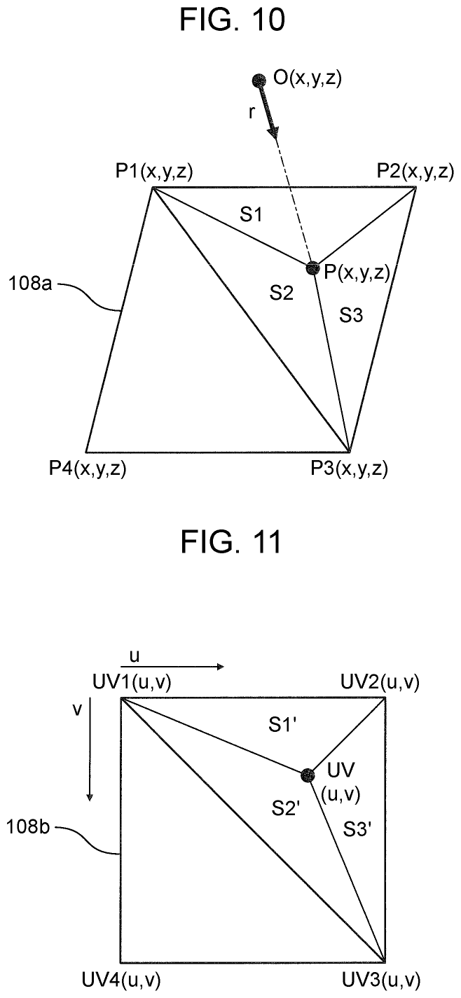

Hereinafter, generation processing of the printed image data performed by printed image data generator 113 will be described in more detail. FIG. 10 is a view exemplifying a part of surface decoration shape model 108a. FIG. 11 is a view exemplifying a part of surface decoration image 108b.

Surface decoration shape model 108a treats the curved surface of complicated workpiece 102 as a set of triangular surfaces called polygons. FIG. 10 shows two triangles including two triangles, a triangle having points P1, P2, and P3 and a triangle having points P1, P3, and P4.

Furthermore, in surface decoration image 108b shown in an example in FIG. 11, coordinates of pixels corresponding to vertices of the polygon of surface decoration shape model 108a are provided by the UV map. As a result, the coordinates of the pixel on surface decoration image 108b corresponding to the vertex of each polygon of surface decoration shape model 108a are uniquely obtained.

Furthermore, since binary images 110a to 110d are images generated by converting surface decoration image 108b into the raster image, the coordinates of each pixel do not change. Therefore, if the coordinates of the pixel on surface decoration image 108b corresponding to the vertex of each polygon of surface decoration shape model 108a are uniquely obtained, the coordinates of the pixels on binary images 110a to 110d corresponding to the vertex of each polygon of surface decoration shape model 108a are also uniquely obtained.

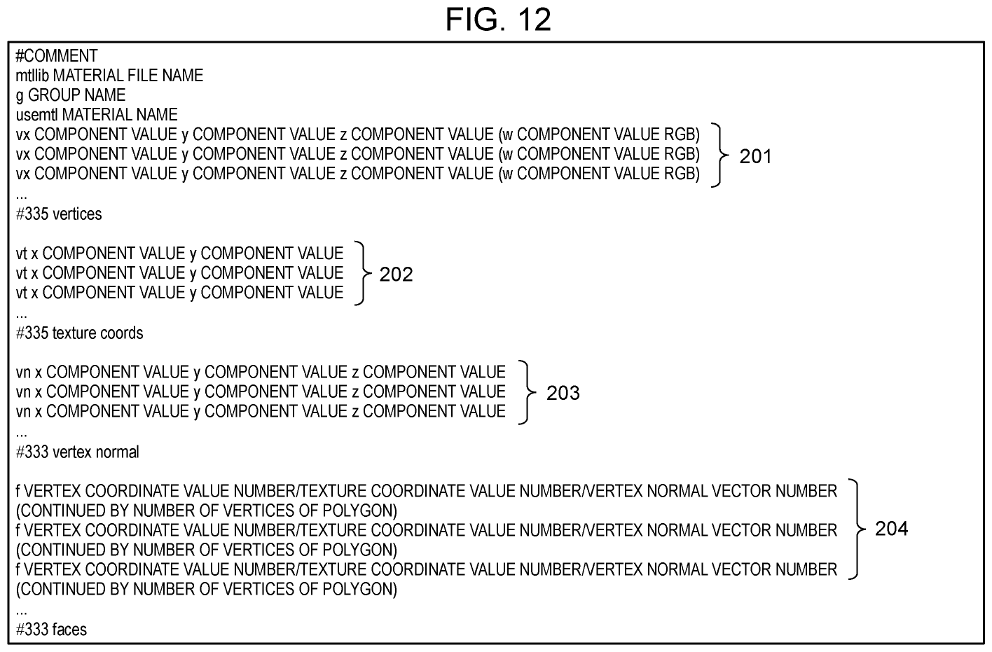

Here, the UV map will be described. FIG. 12 is a view showing a description example of a UV map according to the WaveFrontObj file format. The WaveFrontObj file format is one of formats for describing 3D model data.

The UV map shown in FIG. 12 includes coordinates 201 of vertices (P1, P2, P3, . . . ) constituting each polygon of surface decoration shape model 108a, coordinates 202 of vertices (UV1, UV2, UV3, . . . ) in surface decoration image 108b (corresponding to the texture image), vertex normal vector 203 representing front and back surfaces of each polygon surface of surface decoration shape model 108a, coordinates of vertices constituting the polygons, coordinates 202 of vertices in surface decoration image 108b, and polygon configuration information 204 indicating the correspondence relationship of vertex normal vector 203.

With this UV map, the coordinates of the vertices constituting the polygon surface and the coordinates of surface decoration image 108b can be made to correspond to each other on a one-to-one basis. For example, in the examples of FIG. 10 and FIG. 11, point P1 may correspond to UV1, point P2 may correspond to UV2, point P3 may correspond to UV3, and point P4 may correspond to UV4 on a one-to-one basis.

Here, it is assumed that point O in FIG. 10 indicates a position of the nozzle hole of inkjet head 101, and that vector r having point O as a starting point is a vector directed in a direction perpendicular to the nozzle surface of inkjet head 101.

Printed image data generator 113 determines whether or not a straight line passing through point O and extending in the same direction as vector r intersects with a polygon constituted by points P1, P2, and P3, and calculates coordinates of intersection point P in a case where the straight line intersects with the polygon.

Next, printed image data generator 113 calculates the positions of points UV on surface decoration image 108b corresponding to intersection point P, and generates the printed image data at the position of intersection point P.

For example, printed image data generator 113 detects three points UV1, UV2, and UV3 of surface decoration image 108b corresponding to three points P1, P2, and P3 constituting the polygon with reference to the UV map.

Then, printed image data generator 113 calculates coordinates indicating the position of point UV so that a ratio (S1′:S2′:S3′) of the areas of three triangles formed by the three points UV1, UV2, and UV3 and point UV is the same as the ratio (S1:S2:S3) of the areas of the three triangles formed by three points P1, P2, and P3 and intersection point P constituting the polygon of surface decoration shape model 108a.

In this manner, printed image data generator 113 obtains the three points UV1, UV2, and UV3 of surface decoration image 108b corresponding to three points P1, P2, and P3 of the polygon of three-dimensional shape model 104a, and determines point UV of surface decoration image 108b corresponding to intersection point P based on a positional relationship between three points P1, P2, and P3 and intersection point P.

Thereafter, printed image data generator 113 acquires binary (0 or 1) information in each of CMYK binary images 110a to 110d of the pixel corresponding to the position of point UV.

Printed image data generator 113 executes the above processing on each polygon, and generates data indicating whether or not each ink of CMYK is to be ejected for each pixel as printed image data using the binary information acquired for each polygon.

Note that, here, printed image data generator 113 obtains the position of point UV using the ratio of the area of the triangle, but the method of obtaining point UV is not limited thereto, and the position of point UV may be obtained based on the positional relationship between three points P1, P2, and P3 defined as follows and intersection point P.

For example, in FIG. 10 and FIG. 11, printed image data generator 113 may obtain the position of point UV so that the ratio of each distance from each side of the triangle having the three points UV1, UV2, and UV3 as vertices to point UV is the same as the ratio of each distance from each side of a polygon having three points P1, P2, and P3 as vertices to intersection point P of surface decoration shape model 108a.

Furthermore, in FIG. 10 and FIG. 11, printed image data generator 113 may obtain the position of point UV so that the ratio of each distance from each vertex UV1, UV2, and UV3 of the triangle having the three points UV1, UV2, and UV3 as vertices is the same as the ratio of each distance from each vertex P1, P2, and P3 of the polygon of surface decoration shape model 108a to intersection point P.

Printed image data storage 114 stores the printed image data generated by printed image data generator 113.

Print processing apparatus 10B includes inkjet head 101, multi-axis controller 115, multi-axis robot 116, and print controller 117.

Inkjet head 101 has a plurality of nozzles, and ejects ink from each nozzle to perform printing on the printing target object.

Multi-axis controller 115 reads trajectory data 106a stored in trajectory data storage 106, converts the trajectory data into an operation amount given to each axis of multi-axis robot 116, and outputs the operation amount information to multi-axis robot 116.

Multi-axis robot 116 operates each axis using the information of the operation amount acquired from multi-axis controller 115, and moves or rotates workpiece 102 fixed to the arm.

Using the printed image data stored in printed image data storage 114 and the information of the operation amount acquired from multi-axis controller 115, print controller 117 controls inkjet head 101 in accordance with movement of multi-axis robot 116 to eject ink, thereby printing an image on the surface of workpiece 102.

Here, print controller 117 may execute a process of controlling inkjet head 101 so as not to print the same pixel redundantly in a case where inkjet head 101 performs printing following a certain trajectory and then performs printing following an adjacent trajectory. As a result, an occurrence of moire can be suppressed. Hereinafter, a method for preventing redundant printing of pixels will be described.

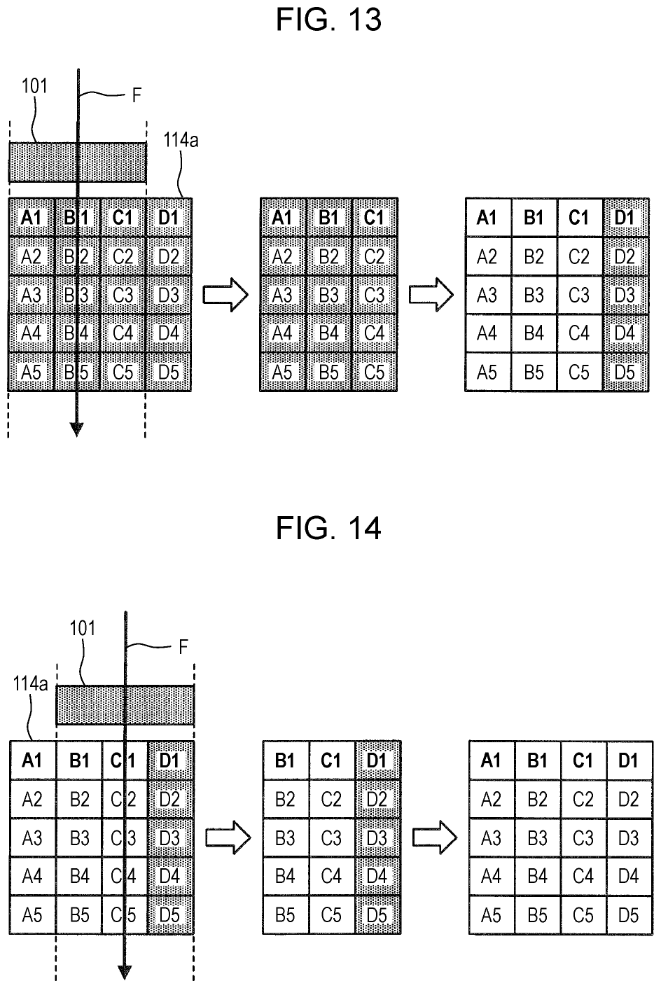

FIG. 13 is a view showing an example of the first-stage print control processing, and FIG. 14 is a view showing an example of the second and subsequent stages of print control processing. Here, A1 to A5, B1 to B5, C1 to C5, and D1 to D5 indicate pixels included in printed image data 114a. Furthermore, arrow F indicates a moving direction when inkjet head 101 performs printing.

As shown in FIG. 13, print controller 117 acquires, from printed image data 114a, the binary (0 or 1) information indicating whether or not to eject ink for pixels of three rows (three columns of A1 to A5, B1 to B5, and C1 to C5) corresponding to widths of the plurality of nozzles of inkjet head 101.

Then, print controller 117 performs printing on these three columns according to the binary information, and thereafter, sets the values of the pixels of these three columns in printed image data 114a to “0” to set the pixels not to eject ink. The pixels whose pixel values are set to “0” are represented by white squares in FIG. 13.

As shown in FIG. 14, in the second-stage print control processing, similarly to the first-stage print control processing, print controller 117 acquires, from printed image data 114a, the binary (0 or 1) information indicating whether or not ink should be ejected for pixels of three rows (three columns of B1 to B5, C1 to C5, and D1 to D5) corresponding to the widths of the plurality of nozzles of inkjet head 101.

Here, for the columns of pixels B1 to B5 and the columns of pixels C1 to C5, the value “0” is set as the pixels that do not eject ink by the first-stage processing. Therefore, print controller 117 does not perform printing for the columns of pixels B1 to B5 and the columns of pixels C1 to C5, and performs printing only for the columns of pixels D1 to D5 according to the binary information of those pixels.

As described above, for the pixel for which the binary information has been once acquired, print controller 117 sets the value of the pixel to “0” and sets the pixel to a pixel that does not eject ink, thereby making it possible to prevent redundant printing even in a case where there is a portion where the trajectory of inkjet head 101 during printing overlaps.

Note that, it is desirable that the printing resolution during printing on workpiece 102 actually having a three-dimensional shape and the resolution of surface decoration image 108b, which is a two-dimensional image, coincide with each other, but it is difficult to completely match these.

In a case where the printing resolution is higher than the resolution of surface decoration image 108b, white spots where a part of the image is not printed occur. Therefore, print controller 117 may set the printing resolution to be the same as the resolution of surface decoration image 108b or lower than the resolution of surface decoration image 108b to prevent white spots.

Furthermore, model generator 103, trajectory data generator 105, surface decoration unit 107, RIP processing unit 109, data acquisition unit 112, printed image data generator 113, multi-axis controller 115, and print controller 117 shown in FIG. 3 are realized by a processor such as a central processing unit (CPU). These may be realized by one processor or may be realized by a plurality of processors.

Furthermore, shape model storage 104, trajectory data storage 106, surface decoration data storage 108, two-dimensional image data storage 110, nozzle position data storage 111, and printed image data storage 114 are realized by a storage device such as a memory and a hard disk drive. These may be realized by one storage device or may be realized by a plurality of storage devices.

As described above, according to the printed image data generation method of the first exemplary embodiment, in the data acquisition step, the data indicating three-dimensional shape model 104a imitating the printing target object and the data indicating surface decoration image 108b that is the two-dimensional image for decorating the surface of the printing target object are acquired, and in the printed image data generation step, the position of the surface of three-dimensional shape model 104a on which the ink ejected from the nozzle is to land is calculated, the pixel of surface decoration image 108b corresponding to the position of the surface is determined, and the printed image data to be printed on the printing target object is generated based on the information of the pixel.

In this printed image data generation method, by causing print processing apparatus 10B to perform printing using the printed image data generated in this manner, even when the surface of the printing target object is the free curved surface, the designer can easily print an image without performing work such as manually expanding and contracting the printed image.

Furthermore, according to the printed image data generation method of the first exemplary embodiment, the data acquisition step further includes acquiring data indicating the nozzle position of inkjet head 101 including the plurality of nozzles, and the printed image data generation step includes calculating the position of the surface described above corresponding to one of nozzles, determining the pixel of surface decoration image 108b corresponding to the position, and generating the printed image data to be printed on the printing target object based on the information of the pixel of surface decoration image 108b.

In this printed image data generation method, by causing print processing apparatus 10B to perform printing using the printed image data generated in this manner, even in a case where inkjet head 101 moves along the curve, the influence of the position of the nozzle is considered in advance, so that the image can be easily printed without performing complicated correction on the pixels of the printed image.

Furthermore, according to the printed image data generation method of the first exemplary embodiment, in the printed image data generation step, points on surface decoration image 108b corresponding to vertices of the polygon of three-dimensional shape model 104a is obtained, the positional relationship between the vertices of the polygon and the position of the surface described above is obtained, and the pixel of surface decoration image 108b corresponding to the position of the surface is determined based on the points on obtained surface decoration image 108b and the obtained positional relationship.

In this printed image data generation method, by determining the pixels in this manner, it is possible to appropriately determine the pixels of surface decoration image 108b corresponding to the position of the surface.

Furthermore, according to the printed image data generation method of the first exemplary embodiment, the positional relationship is specified by an area ratio of a plurality of triangles. Each of the plurality of triangles has three vertices that include two vertices of the polygon and the position of the surface.

In this printed image data generation method, by using such a positional relationship, it is possible to effectively determine the pixel of surface decoration image 108b corresponding to the position of the surface.

Furthermore, the printing method of the first exemplary embodiment includes the printed image data generation method.

In this printing method, by performing printing using the printed image data generated by the printed image data generation method, even when the surface of the printing target object is the free curved surface, the designer can easily print an image without performing work such as manually expanding and contracting the printed image.

Furthermore, according to the printing method of the first exemplary embodiment, in the print control step, the pixel from which the information indicating whether or not to eject the ink is read from the printed image data is set as the pixel that does not eject the ink.

In this printing method, by performing the setting in this way, even when there is a portion where the trajectory of inkjet head 101 during printing overlaps, the redundant printing can be prevented.

Furthermore, according to the printing method of the first exemplary embodiment, in the print control step, the printing resolution during printing on the printing target object is set to be the same as the resolution of surface decoration image 108b or lower than the resolution of surface decoration image 108b.

In this printing method, by performing the setting in this manner, it is possible to prevent the occurrence of white spots where a part of the image is not printed.

Furthermore, according to printed image data generation apparatus 10A of the first exemplary embodiment, data acquisition unit 112 acquires data indicating three-dimensional shape model 104a imitating the printing target object and data indicating surface decoration image 108b, which is a two-dimensional image for decorating the surface of the printing target object. Printed image data generator 113 calculates the position of the surface of three-dimensional shape model 104a on which the ink ejected from the nozzle lands, determines the pixel of surface decoration image 108b corresponding to the position of the surface, and generates the data of the printed image to be printed on the printing target object based on the information of the pixel.

Printed image data generation apparatus 10A causes print processing apparatus 10B to perform printing using the printed image data generated in this manner, so that even when the surface of the printing target object is the free curved surface, the designer can easily print an image without performing work such as manually expanding and contracting the printed image.

### Second Exemplary Embodiment

In an actual printing apparatus, the landing position of the ink ejected from inkjet head 101 may deviate depending on the distance between inkjet head 101 and workpiece 102. In the second exemplary embodiment, a method of correcting this deviation will be described in detail.

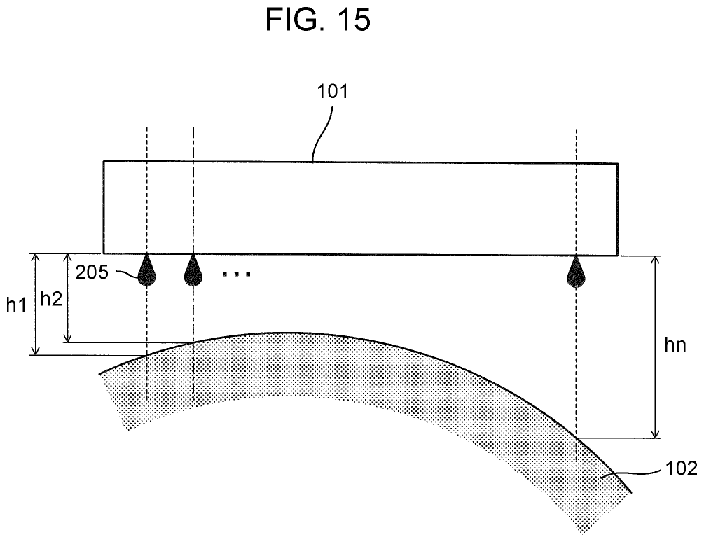

FIG. 15 is a view for describing a deviation of a landing position of ink 205 ejected from inkjet head 101.

As shown in an example in FIG. 15, in a case where printing is performed on workpiece 102 having the curved surface, distances h1, h2, . . . , hn between inkjet head 101 and workpiece 102 are not constant.

When performing printing on workpiece 102, ink 205 is ejected while moving inkjet head 101 relative to workpiece 102. Therefore, when distances h1, h2, . . . , hn are different for each nozzle, the landing position of ink 205 may be deviated for each nozzle, and in this case, a desired printing result cannot be obtained.

In view of the circumstances above, the present second exemplary embodiment discloses a printed image data generation apparatus, a printing method, and a printed image data generation method capable of easily correcting the deviation of the landing position of ink 205.

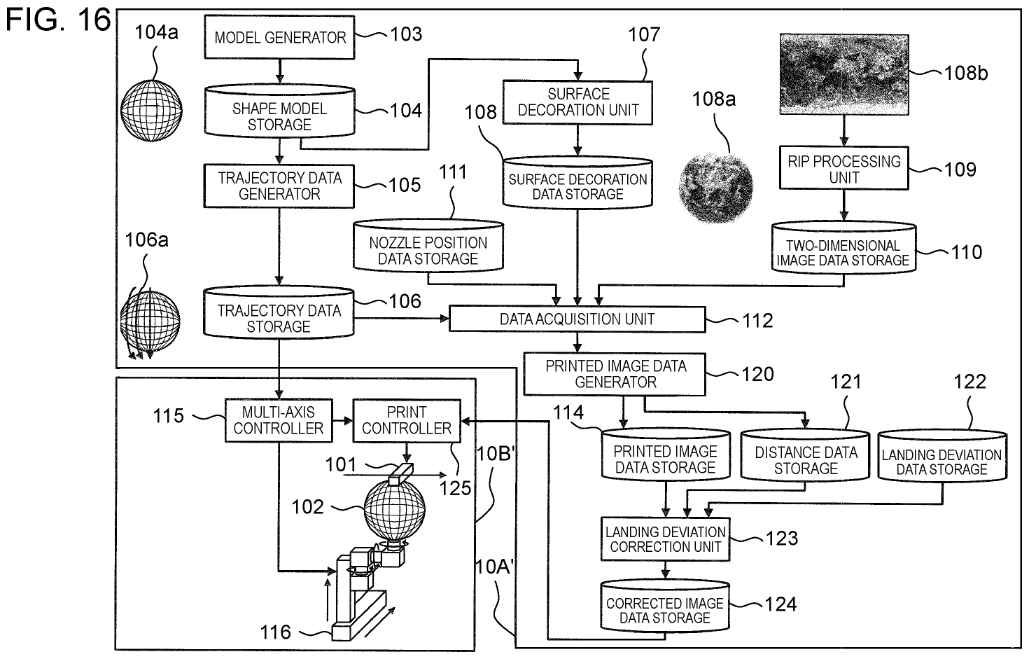

FIG. 16 is a view showing an example of the printing apparatus according to the second exemplary embodiment. As in the first exemplary embodiment, the printing apparatus shown in FIG. 16 ejects the ink from the nozzle provided in inkjet head 101 to decorate the surface of workpiece 102 having the three-dimensional shape.

The printing apparatus includes printed image data generation apparatus 10A′ and print processing apparatus 10B′. Printed image data generation apparatus 10A′ generates printed image data to be printed on workpiece 102 as the printing target object. Print processing apparatus 10B′ performs printing on workpiece 102 using the printed image data generated by printed image data generation apparatus 10A.

Hereinafter, a printing apparatus in which printed image data generation apparatus 10A′ and print processing apparatus 10B′ are integrated will be described, but it is similar to the first exemplary embodiment that printed image data generation apparatus 10A′ and print processing apparatus 10B′ may be separate apparatuses.

Printed image data generation apparatus 10A′ further includes distance data storage 121, landing deviation data storage 122, landing deviation correction unit 123, and corrected image data storage 124 in addition to the components of printed image data generation apparatus 10A shown in FIG. 3. Furthermore, printed image data generator 113 is replaced with printed image data generator 120.

Furthermore, in print processing apparatus 10B′, print controller 117 is replaced with print controller 125.

Other configurations in FIG. 16 are similar to the configurations denoted with the same reference numerals in FIG. 3, and thus differences from the printing apparatus shown in FIG. 3 will be described below.

Printed image data generator 120 calculates the position of the surface of three-dimensional shape model 104a on which the ink ejected from the nozzle lands, determines the pixels of binary images 110a to 110d which are two-dimensional images corresponding to the position of the surface, and generates the data of the printed image to be printed on the printing target object based on the information of the pixels by the same method as printed image data generator 113 in the first exemplary embodiment.

Furthermore, printed image data generator 120 according to the second exemplary embodiment calculates the distance between point O and intersection point P as shown in FIG. 10, that is, the distance between the nozzle hole and the surface of surface decoration shape model 108a. Printed image data generator 120 calculates this distance for each pixel of the printed image data, and generates distance data including information of the distance associated with each pixel.

Distance data storage 121 stores the distance data generated by printed image data generator 120.

Landing deviation data storage 122 stores the landing deviation data. The landing deviation data is data indicating how much the landing position of the ink ejected from the nozzle hole deviates from a target position due to the separation between the nozzle hole and the surface of workpiece 102 to be printed.

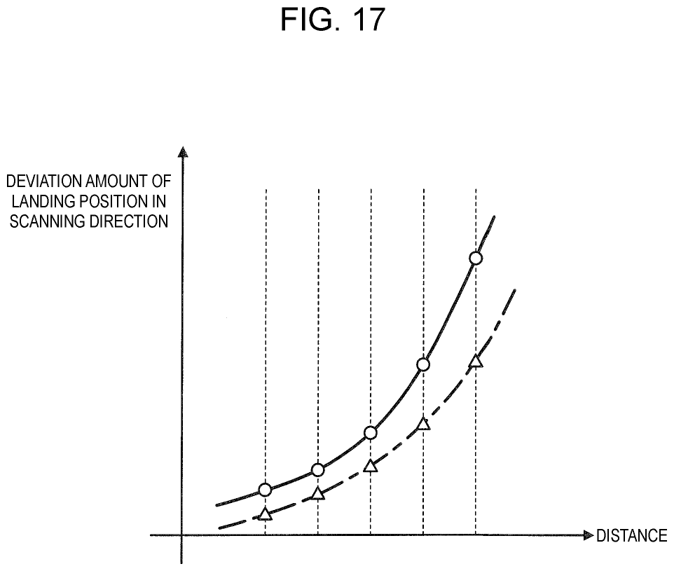

FIG. 17 is a view for describing the landing deviation data. In FIG. 17, a vertical axis indicates a deviation amount of the landing position in the scanning direction of inkjet head 101 during printing, and a horizontal axis indicates the distance between the nozzle hole and the surface of surface decoration shape model 108a.

A circle in FIG. 17 indicates a relationship between the deviation amount of the landing position obtained by an experiment for a certain nozzle and the distance. Furthermore, a solid line is an approximate curve that approximates the relationship between the deviation amount of the landing position indicated by the circle and the distance. Furthermore, a triangle mark indicates the relationship between the deviation amount of the landing position obtained by experiment with respect to another nozzle and the distance. Furthermore, an alternate long and short dash line is an approximate curve that approximates the relationship between the deviation amount of the landing position indicated by the triangle mark and the distance.

The landing deviation data is data including information indicating the relationship between the deviation amount of the landing position and the distance as a table or an approximate expression for each nozzle. As described below, the deviation of the landing position is corrected using the landing deviation data.

Based on the distance data stored in distance data storage 121 and the landing deviation data stored in landing deviation data storage 122, landing deviation correction unit 123 generates a deviation correction image in which the positions of the pixels included in the printed image data stored in printed image data storage 114 are corrected.

For example, landing deviation correction unit 123 acquires, from the distance data, information of the distance between the nozzle hole and the surface of surface decoration shape model 108a during printing each pixel included in the printed image data.

Subsequently, landing deviation correction unit 123 acquires information of the deviation amount of the landing position corresponding to the distance from the landing deviation data, corrects the printed image data, and generates the corrected image data in which the positions of the pixels are deviated in advance so as to land at the target position in actual printing. By using such corrected image data during printing, the printing apparatus can correct the deviation of the landing position of the ink due to the distance between inkjet head 101 and workpiece 102.

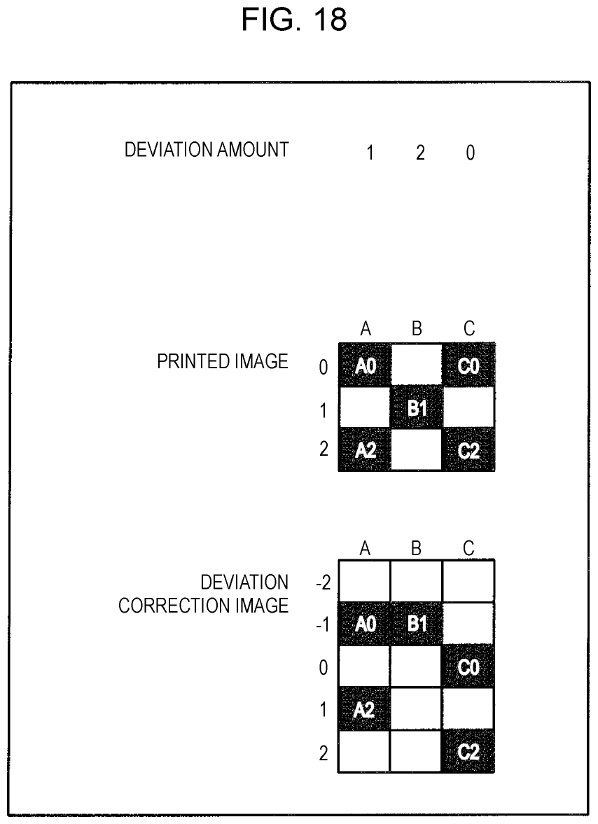

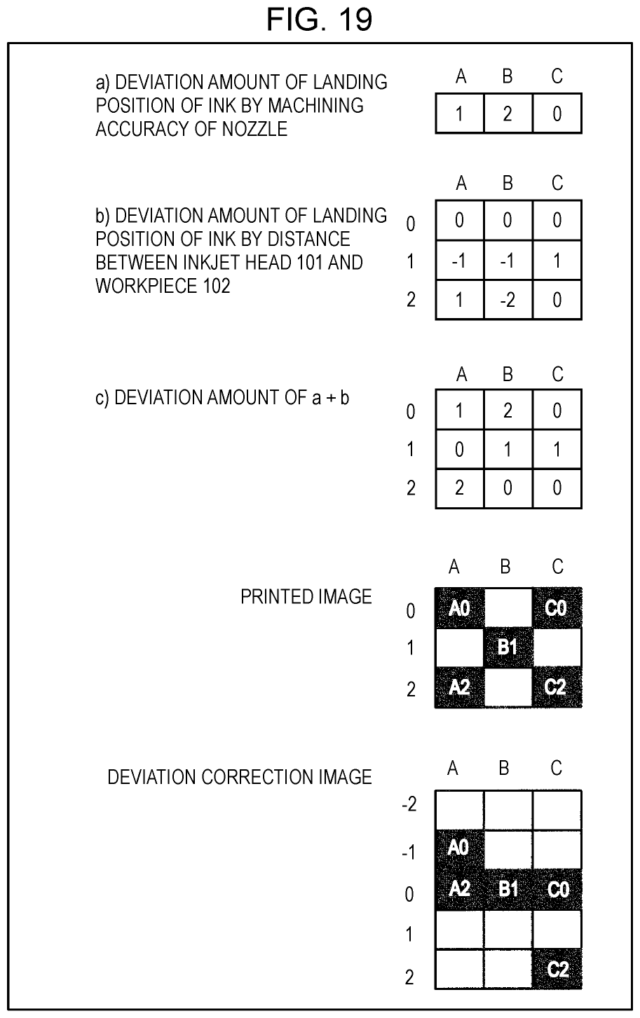

Here, a difference between general deviation correction and deviation correction according to the second exemplary embodiment will be described. FIG. 18 is a view for describing the general deviation correction. FIG. 19 is a view for describing the deviation correction according to the second exemplary embodiment.

The deviation amounts “1”, “2”, and “0” shown in FIG. 18 are deviation amounts of the landing positions of the ink of the nozzles that respectively eject the ink to column A, column B, and column C of the printed image in inkjet head 101. This deviation occurs due to a machining error of the nozzle.

When inkjet head 101 prints a printed image having pixels “A0”, “A2”, “B1”, “C0”, and “C2” to which ink is to be ejected, landing deviation correction unit 123 generates a deviation correction image in which the positions of the pixels are corrected by “−1” for the nozzle that ejects ink in column A and “−2” for the nozzle that ejects ink in column B.

By using such a deviation correction image, the deviation due to the machining error of the nozzle is corrected, but in this method, it is difficult to correct the deviation of the landing position of the ink due to the distance between inkjet head 101 and workpiece 102 as described in FIG. 15.

FIG. 19 shows a case of correcting the deviation of the landing position of the ink due to the distance between inkjet head 101 and workpiece 102 in addition to the deviation of the landing position of the ink due to the machining error of the nozzle.

In this example, (a) of FIG. 19 shows the deviation amount of the landing position of the ink due to the machining error of the three nozzles in a case of ejecting the ink in column A, column B, and column C of the printed image. The deviation amounts are “1”, “2”, and “0” as in the case of FIG. 18.

Furthermore, (b) of FIG. 19 shows the deviation amount of the landing position of the ink according to the distance between inkjet head 101 and workpiece 102. The deviation amount is, for example, “−1”, “−1”, and “1” in a first row.

(c) of FIG. 19 shows a total deviation amount of (a) of FIG. 19 and (b) of FIG. 19. The deviation amount is, for example, a sum of “1”, “2”, and “0” of the deviation amount of the landing position of the ink due to the machining error of the nozzle and “−1”, “−1”, and “1” of the deviation amount of the landing position of the ink due to the distance between inkjet head 101 and workpiece 102 in the first row, and is “0”, “1”, and “1”.

Therefore, when inkjet head 101 prints a printed image having the pixels “A0”, “A2”, “B1”, “C0”, and “C2” to which ink is to be ejected, landing deviation correction unit 123 generates a deviation correction image in which the positions of the pixels are corrected by “−1” for a pixel “A0”, “−2” for a pixel “A2”, and “−1” for a pixel “B1”. Since the deviation amount of the pixels “C0” and “C2” is “0”, the correction is not performed.

By using such a deviation correction image, the printing apparatus can correct not only the deviation due to the machining error of the nozzle but also the deviation of the landing position of the ink due to the distance between inkjet head 101 and workpiece 102.

Returning to the description of FIG. 16, corrected image data storage 124 stores the corrected image data generated by landing deviation correction unit 123.

Using the corrected image data stored in corrected image data storage 124 and the information of the operation amount given to each axis of multi-axis robot 116 acquired from multi-axis controller 115, print controller 125 controls inkjet head 101 in accordance with the movement of multi-axis robot 116 to eject ink, thereby printing an image on the surface of workpiece 102.

Note that, in FIG. 17, a case where the landing deviation data includes the information of the deviation amount of one landing position with respect to one nozzle has been described. However, since some the printing apparatus performs reciprocating printing to shorten printing time, separate landing deviation data may be used for one nozzle in a forward path and a backward path.

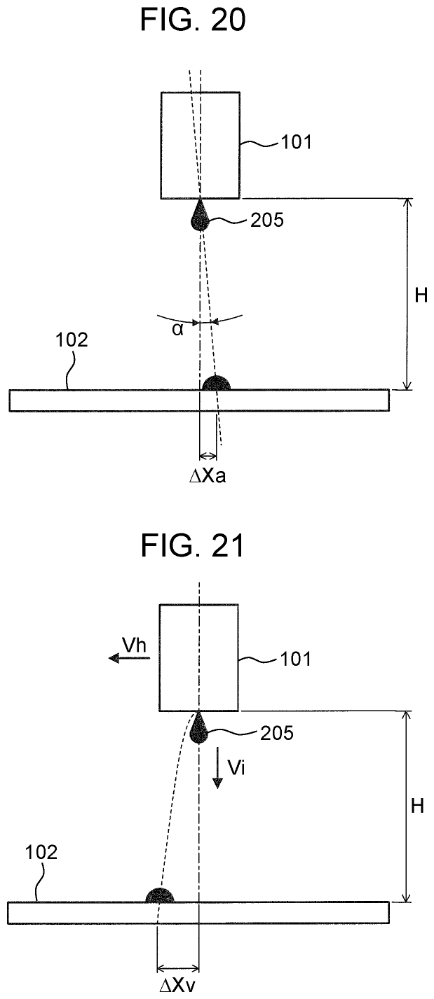

Hereinafter, advantages of using different landing deviation data in the forward path and the backward path will be described. FIG. 20 is a view for describing the deviation of the landing position due to the difference in ejection angle for each nozzle, and FIG. 21 is a view for describing the deviation of the landing position caused by the difference in ejection speed for each nozzle.

As shown in FIG. 20, ink 205 ejected from the nozzles of inkjet head 101 is ejected in a direction inclined by angle α from a vertical direction due to the machining error for each nozzle. Here, when the distance between inkjet head 101 and workpiece 102 is H, ink 205 lands at a position deviated by ΔXa (=H×tan(α)) from the target position.

On the other hand, in a case of performing the reciprocating printing, the deviation of the landing position due to the ejection angle becomes a constant value ΔXa regardless of a printing direction. However, when ejection speed Vi of ink 205 is different for each nozzle, as shown in FIG. 21, in a case where inkjet head 101 is moving at speed Vh, the position where the ink lands on workpiece 102 deviates from the target position by a certain amount ΔXv.

For example, deviation amount ΔXv increases in proportion to distance H between inkjet head 101 and workpiece 102 and in inverse proportion to ejection speed Vi.

Furthermore, FIG. 21 shows a case where inkjet head 101 moves to a left side at the speed Vh, but in a case where this is the forward movement, inkjet head 101 moves to a right side at the speed Vh in the backward movement. In this case, the direction in which the landing position is deviated is opposite to the direction shown in FIG. 21.

Furthermore, the deviation of the landing position is also affected by an air flow, and a magnitude of the influence of the air flow on the deviation of the landing position may be different between the forward path and the backward path.

For this reason, landing deviation correction unit 123 may use different landing deviation data in the forward path and the backward path for one nozzle and generate the corrected image data for each nozzle.

Furthermore, model generator 103, trajectory data generator 105, surface decoration unit 107, RIP processing unit 109, data acquisition unit 112, multi-axis controller 115, printed image data generator 120, landing deviation correction unit 123, and print controller 125 shown in FIG. 16 are realized by a processor such as a CPU. These may be realized by one processor or may be realized by a plurality of processors.

Furthermore, shape model storage 104, trajectory data storage 106, surface decoration data storage 108, two-dimensional image data storage 110, nozzle position data storage 111, printed image data storage 114, distance data storage 121, landing deviation data storage 122, and corrected image data storage 124 are realized by a storage device such as a memory and a hard disk drive. These may be realized by one storage device or may be realized by the plurality of storage devices.

As described above, in the printed image data generation method of the second exemplary embodiment, in the landing deviation correction step, the printed image data is corrected based on the landing deviation data indicating the relationship between the position of the surface of three-dimensional shape model 104a on which the ink ejected from the nozzle lands, the distance between the nozzle, and the deviation of the landing position of the ink, and the distance data indicating the distance between the nozzle and the position of the surface of the three-dimensional shape model.

In this printed image data generation method, by performing such processing, the deviation of the landing position of the ink can be easily corrected.

### Third Exemplary Embodiment

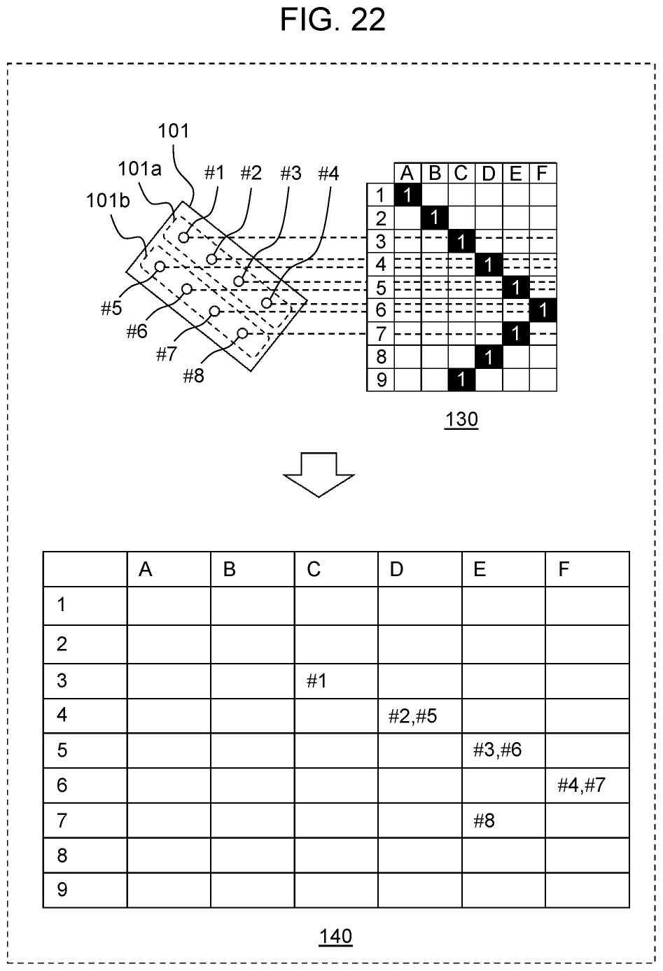

When inkjet head 101 moves on the free curved surface, pixels over which two or more nozzles pass may be generated. For example, in FIG. 22, nozzle #2 and nozzle #5 pass over pixel “D4”. Nozzle #2 and nozzle #5 eject inks of the same color. When both nozzle #2 and nozzle #5 eject ink to pixel “D4”, excessive ink is applied to a position corresponding to pixel “D4” on the three-dimensional object (the printing target object). A simple measure to avoid excessive ink application is that in a case where two or more nozzles pass over one pixel, only one of the nozzles ejects ink to that pixel. According to this measure, in the example of FIG. 22, the pixels “C3”, “D4”, “E5”, “F6”, and “E7” receive ink drop by drop.

However, the simple measure described above may cause a problem that the two-dimensional image on the three-dimensional object becomes thin. This is because when inkjet head 101 moves on the free curved surface, a pixel that does not pass over any nozzle may occur. For example, in FIG. 22, none of nozzles #1 to #8 passes over pixel “A1”. Pixel “A1” requires ink application, but cannot receive ink from any of the nozzles. In the example of FIG. 22, binarized image 130 requests 9 drops of ink in 54 pixels. However, in the above simple countermeasure, only 5 drops of ink are applied in 54 pixels. As a result, the two-dimensional image on the three-dimensional object may be thin on average.

The present exemplary embodiment provides a printed image data generation apparatus that copes with such a problem.

Similarly to the first exemplary embodiment, the printed image data generation apparatus prepares three-dimensional model data indicating a three-dimensional model generated from the three-dimensional object.

As in the first exemplary embodiment, the printed image data generation apparatus prepares binarized image data representing binarized image 130 generated from the two-dimensional image. Binarized image 130 is, for example, the same as binary image 110d of the first exemplary embodiment. Binarized image 130 includes the plurality of binarized image pixels (54 pixels in FIG. 22). Each of the plurality of binarized image pixels has a pixel value indicating presence or absence of a color. As in the first exemplary embodiment, a pixel value “1” indicates having a color. The pixel value “0” indicates no color. In FIG. 22, the pixel value “0” is omitted.

The printed image data generation apparatus prepares the nozzle trajectory data indicating the plurality of trajectories in which the plurality of nozzles (#1 to #8 in FIG. 22) included in inkjet head 101 move. For example, the printed image data generation apparatus may calculate the nozzle trajectory data based on the trajectory data indicating the trajectory of inkjet head 101 and the nozzle position data indicating the position of each of the plurality of nozzles in inkjet head 101.

The printed image data generation apparatus generates printed image data 140 based on the binarized image data and the nozzle trajectory data. As shown in FIG. 22, printed image data 140 includes a plurality of printed image pixels corresponding one-to-one to the plurality of binarized image pixels. Each of the plurality of printed image pixels has a pixel value indicating a nozzle assignment. For example, as shown in FIG. 22, printed image pixel “D4” has a pixel value indicating that nozzle #2 and nozzle #5 have been assigned.

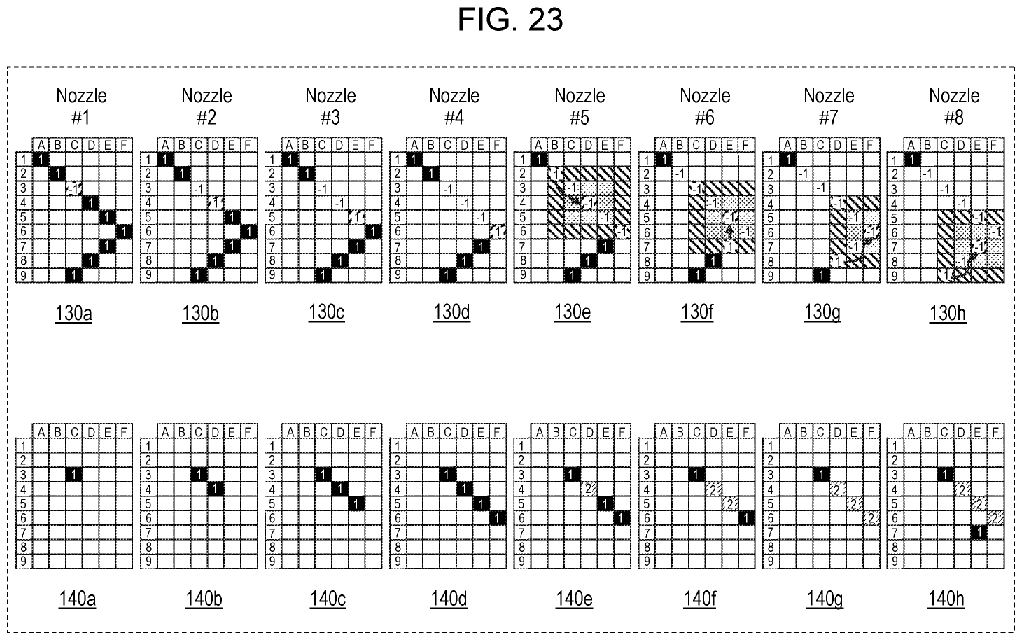

Hereinafter, the algorithm for generating printed image data 140 will be described with reference to FIG. 23.

The printed image data generation apparatus determines that nozzle #1 passes over binarized image pixel “C3” based on the trajectory of nozzle #1 and binarized image 130a. As shown in printed image data 140a, the printed image data generation apparatus assigns nozzle #1 to printed image pixel “C3” corresponding to binarized image pixel “C3”. As shown in binarized image 130b, the printed image data generation apparatus changes the pixel value of binarized image pixel “C3” to “−1”. A pixel value “−1” indicates that it has a color and that any nozzle has already been assigned.

Similarly, the printed image data generation apparatus determines that nozzle #2 passes over binarized image pixel “D4” based on the trajectory of nozzle #2 and binarized image 130b. As shown in printed image 140b, the printed image data generation apparatus assigns nozzle #2 to printed image pixel “D4” corresponding to binarized image pixel “D4”. As shown in binarized image 130c, the printed image data generation apparatus changes the pixel value of binarized image pixel “D4” to “−1”.

Similarly, as shown in the printed images 140c and 140d, the printed image data generation apparatus assigns the nozzles #3 and #4 to the printed image pixels “E5” and “F6”, respectively.

The printed image data generation apparatus determines that nozzle #5 passes over binarized image pixel “D4” based on the trajectory of nozzle #5 and binarized image 130e. Binarized image pixel “D4” has the pixel value “−1”. The printed image data generation apparatus searches for the binarized image pixel having the pixel value “1” located within the predetermined distance from the binarized image pixel as the nozzle passes over the binarized image pixel having the pixel value “−1”. In the example of FIG. 23, the printed image data generation apparatus searches for the binarized image pixel having the pixel value “1” located within the predetermined distance from binarized image pixel “D4”. The printed image data generation apparatus determines binarized image pixel “B2” having the pixel value “1” located within the predetermined distance from binarized image pixel “D4”. As shown in printed image 140e, in response to the determination of binarized image pixel “B2”, the printed image data generation apparatus assigns nozzle #5 in addition to nozzle #2 to printed image pixel “D4” corresponding to binarized image pixel “D4”. In a case where the binarized image pixel having the pixel value “1” is not within the predetermined distance, the printed image data generation apparatus does not assign nozzle #5 to printed image pixel “D4”.

In FIG. 22, the predetermined distance is 2 pixels. The predetermined distance may be adjustable by a user of the printed image data generation apparatus.

Similarly, the printed image data generation apparatus determines that nozzle #6 passes over binarized image pixel “E5” based on the trajectory of nozzle #6 and binarized image 130f. Binarized image pixel “E5” has the pixel value “−1”. The printed image data generation apparatus searches for a binarized image pixel having the pixel value “1” located within the predetermined distance from binarized image pixel “E5”, and determines binarized image pixel “E7”. As shown in printed image 140f, in response to the determination of binarized image pixel “E7”, the printed image data generation apparatus assigns nozzle #6 in addition to nozzle #3 to printed image pixel “E5” corresponding to binarized image pixel “E5”.

Similarly, as shown in printed images 140g and 140h, the printed image data generation apparatus assigns nozzles #7 and #8 to printed image pixels “F6” and “E7”, respectively.

In the third exemplary embodiment, the printed image data generation apparatus can prevent the two-dimensional image on the three-dimensional object from becoming thin on average. Specifically, in the example of FIG. 22, binarized image 130 requests 9 drops of ink in 54 pixels. In the simple countermeasure, only 5 drops of ink are applied in 54 pixels. On the other hand, in the generation algorithm of the printed image of third exemplary embodiment, 8 drops of ink are applied in 54 pixels.

As described above, in the present exemplary embodiment, the printed image data generation apparatus determines that the first nozzle (for example, nozzle #2) passes over the first binarized image pixel (for example, D4) having the pixel value “1” indicating that the first nozzle has a color among the plurality of binarized image pixels. The printed image data generation apparatus assigns the first nozzle (for example, nozzle #2) to the first printed image pixel (for example, D4) corresponding to the first binarized image pixel (for example, D4). The printed image data generation apparatus determines that the second nozzle (for example, #5) different from the first nozzle (for example, nozzle #2) passes over the first binarized image pixel (for example, D4). The printed image data generation apparatus determines the second binarized image pixel (for example, B2) having the pixel value “1” indicating that it has a color located within the predetermined distance from the first binarized image pixel (for example, D4). In response to determining the second binarized image pixel (for example, B2), the printed image data generation apparatus assigns the second nozzle (for example, #5) in addition to the first nozzle (for example, nozzle #2) to the first printed image pixel (for example, D4). As described above, according to the printed image data generation method, the printing method, and the printed image data generation apparatus of the present disclosure, it is possible to improve print quality when surface decoration is performed on the printing target object having a complicated shape.

For example, since satisfactory printing quality cannot be obtained by the conventional method, it is possible to perform the surface decoration even on a printing target object having a complicated surface shape for which there is no choice but to cope with by seal sticking or the like.

Note that, in the first and second exemplary embodiments, RIP processing unit 109 converts surface decoration image 108b into binary images 110a to 110d corresponding to the four colors of CMYK, respectively, and printed image data generators 113, 120 generate printed image data 113a including the binary data indicating whether or not to eject each ink of CMYK for each pixel based on binary images 110a to 110d.

However, the printed image data generation method, the printing method, and the printed image data generation apparatus of the present disclosure are not limited thereto.

For example, RIP processing unit 109 may convert surface decoration image 108b into gradation image data in which gradation corresponding to ejection amount of ink is set for each pixel corresponding to each of four colors of CMYK.

Then, printed image data generators 113, 120 may calculate the position of the surface of three-dimensional shape model 104a on which the ink ejected from the nozzle lands, determine the pixel of the gradation image, which is the two-dimensional image corresponding to the position of the surface, and generate the printed image data including the data of the ejection amount of each ink of CMYK based on the information of the pixel.

For example, 4-bit (“0” to “15”) TIFF data may be used as the gradation image data and the printed image data. In this case, “0” represents the ejection amount of ink of 0, and “1” to “15” represent the ejection amount of ink that increases according to an increase in these numerical values.

According to the printed image data generation method, the printing method, and the printed image data generation apparatus of the present disclosure, an image can be easily printed even when the surface of the printing target object is the free curved surface.

The printed image data generation method, the printing method, and the printed image data generation apparatus of the present disclosure can be applied to a printing apparatus that directly prints an image on various printing target objects having the three-dimensional shape.

What is claimed is:

1. A printed image data generation method comprising:
a data acquisition step of acquiring data indicating a three-dimensional shape model imitating a printing target object and data indicating a two-dimensional image for decorating a surface of the printing target object; and
a printed image data generation step of calculating a position of a surface of the three-dimensional shape model on which ink ejected from a nozzle is to land, determining a pixel of the two-dimensional image corresponding to the position of the surface, and generating data indicating a printed image to be printed on the printing target object based on information of the pixel.

2. The printed image data generation method according to claim 1, wherein
the data acquisition step further includes
acquiring data indicating a nozzle position of an inkjet head including a plurality of nozzles; and
the printed image data generation step includes
calculating the position of the surface corresponding to one of the plurality of nozzles,
determining the pixel of the two-dimensional image corresponding to the position, and
generating data of a printed image to be printed on the printing target object based on information of the pixel of the two-dimensional image.

3. The printed image data generation method according to claim 2, wherein the determining of the pixel of the two-dimensional image in the printed image data generation step includes,
determining a plurality of points on the two-dimensional image corresponding to a respective one of plurality of vertices of a polygon of the three-dimensional shape model,
determining a positional relationship between the plurality of vertices of the polygon and the position of the surface, and
determining the pixel of the two-dimensional image corresponding to the position of the surface based on the plurality of points on the two-dimensional image and the positional relationship.

4. The printed image data generation method according to claim 3, wherein the positional relationship is specified by an area ratio of a plurality of triangles, each of the plurality of triangles having three vertices that includes two vertices of the polygon and the position of the surface.

5. The printed image data generation method according to claim 1, further comprising a landing deviation correction step of correcting data of the printed image based on landing deviation data indicating a relationship between a distance between the nozzle and the position of the surface and a deviation of a landing position of the ink and distance data indicating a distance between the nozzle and the position of the surface of the three-dimensional shape model.

6. A printing method comprising the printed image data generation method according to claim 1.

7. The printing method according to claim 6, further comprising a print control step of setting a pixel from which information indicating whether or not to eject ink from the data of the printed image is read as a pixel that does not eject ink.

8. The printing method according to claim 6, further comprising a print control step of setting printing resolution for printing on the printing target object to be equal to or lower than resolution of the two-dimensional image.

9. A printing method of a two-dimensional image on a three-dimensional object by an inkjet head, the method comprising:
preparing three-dimensional model data indicating a three-dimensional model generated from the three-dimensional object;
preparing binarized image data indicative of a binarized image generated from the two-dimensional image, the binarized image including a plurality of binarized image pixels, each of the plurality of binarized image pixels having a pixel value indicative of presence or absence of a color;
preparing nozzle trajectory data indicating a plurality of trajectories in which a plurality of nozzles included in the inkjet head move; and
generating printed image data based on the binarized image data and the nozzle trajectory data, the printed image data including a plurality of printed image pixels corresponding one-to-one to the plurality of binarized image pixels, each of the plurality of printed image pixels having a pixel value indicative of a nozzle assignment,
wherein the generating of the printed image data includes
determining that a first nozzle of the plurality of nozzles passes over a first binarized image pixel having a pixel value indicative of a presence of a color among the plurality of binarized image pixels,
assigning the first nozzle to a first printed image pixel corresponding to the first binarized image pixel among the plurality of printed image pixels,
determining that a second nozzle different from the first nozzle among the plurality of nozzles passes over the first binarized image pixel,
determining a second binarized image pixel having a pixel value indicating that the binarized image pixel has a color located within a predetermined distance from the first binarized image pixel, and
assigning the second nozzle in addition to the first nozzle to the first printed image pixel in response to determining the second binarized image pixel.

10. A printed image data generation apparatus comprising:
a data acquisition unit that acquires data indicating a three-dimensional shape model imitating a printing target object and data indicating a two-dimensional image for decorating a surface of the printing target object; and
a printed image data generator that calculates a position of a surface of the three-dimensional shape model on which ink ejected from a nozzle is to land, determines a pixel of the two-dimensional image corresponding to the position of the surface, and generates data of a printed image to be printed on the printing target object based on information of the pixel.
